(19) United States
(12) Patent Application Publication
(10) Pub. No.: US 2023/0068883 A1
(43) Pub. Date: Mar. 2, 2023

(54) A MOISTURE-CURABLE SILICONE ELASTOMER COMPOSITION

(71) Applicant: WACKER CHEMIE AG, Munich (DE)

(72) Inventors: Jian NIE, Shanghai (CN); Yanxing LIU, Shanghai (CN)

(73) Assignee: WACKER CHEMIE AG, Munich (DE)

(21) Appl. No.: 17/784,088

(22) PCT Filed: Dec. 12, 2019
(86) PCT No.: PCT/CN2019/124766

§ 371 Date: Jun. 9, 2022

(51) Int. Cl. C08L 83/08; C08G 77/26

(52) U.S. Cl. CPC C08L 83/08; C08G 77/26

(57) ABSTRACT

A virtually non-contaminating, non-corrosive moisture-curable silicone elastomer composition contains a hydroxyl-terminated polyorganosiloxane, a silane B as defined herein, an alkoxysilane crosslinker, an inorganic filler and a catalyst, a cures to form a low-modulus elastomer.

### CROSS REFERENCE TO RELATED APPLICATIONS

This application is the U.S. National Phase of PCT Appln. No. PCT/CN2019/124766 filed Dec. 12, 2019, the disclosure of which is incorporated in its entirety by reference herein.

### BACKGROUND OF THE INVENTION

### 1. Field of the Invention

The present invention relates to a virtually non-contaminating, non-corrosive composition that cures at room temperature to form a low-modulus silicone elastomer.

### 2. Description of the Related Art

With a unique stress-strain behavior, i.e. low stress and high elongation, low modulus, room temperature vulcanized (RTV) silicone rubbers are especially suitable for expansion joints in buildings and for sealing joints between concrete parts, as they can withstand significant deformation caused by temperature, humidity and stress. Existing low-modulus RTV silicone rubbers are usually oxime silane crosslinked, amide silane crosslinked or alkoxy silane crosslinked. Basically, their low modulus properties are achieved, typically, by adding chain extenders or a large amount of plasticizers, for example, adding dimethylbis (methylethylketoxime) silane or methylvinyl-bis (methylethylketoxime) silane as a chain extender and methyltris (methylethylketoxime) silane or vinyltris (methylethylketoxime) silane as a crosslinker in oxime silane crosslinked RTV silicone rubbers, adding a macromolecular chain extender and crosslinker with a special structure in amide silane crosslinked RTV silicone rubbers, and adding an ultra-high-molecular weight (UHMW) base polymer and a large amount of plasticizers in alkoxy silane crosslinked RTV silicone rubbers.

Theoretically, the addition of a chain extender allows the molecular chains of the base polymer, usually an α,ω-dihydroxypolydimethylsiloxane, to extend linearly while crosslinking, which enables a reduced number of crosslinking points and thus low modulus. In this method, however, it is difficult to control the relationship between the chain-extension and crosslinking rates. In particular, for alkoxy silane crosslinked RTV silicone rubbers, few publications have suggested that low modulus can be achieved by adding a chain extender. The reason may be that alkoxy-based chain extenders are not reactive enough to react with the base polymers to achieve a reduced modulus.

At present, low modulus alkoxy silane crosslinked RTV silicone rubbers are usually prepared by adding a plasticizer such as polydimethylsiloxane, but the plasticizer will bleed out after the composition is cured, which causes contamination of surrounding substrates.

Among the prior art, CN101010398B and CN1170888C disclose a curable siloxane composition, which is an oxime silane crosslinked one-component system where a hydroxyl-terminated polysiloxane is used as the main ingredient and methyltris (methylethylketoxime) silane is used as a crosslinker. The system comprises a dimethylbis(s-butylamino) silane, and a second polymeric component (including silane-modified polyurethanes, MDI-terminated polyurethanes, alkyl-modified polyethers).

Given that low modulus oxime silane crosslinked RTV silicone rubbers may cause environmental pollution, that the raw materials of amide silane crosslinked RTV silicone rubbers are rare and expensive, and that the plasticizers added in low modulus alkoxy silane crosslinked RTV compositions will bleed out after curing, leading to construction pollution, it would be desirable to provide a virtually non-contaminating, non-corrosive curable composition, which can cure to form an elastomer with reduced 100% modulus—without the need for a large amount of plasticizers.

### SUMMARY OF THE INVENTION

The present invention relates to a curable composition comprising

(a) a hydroxyl-terminated polyorganosiloxane,

(b) silane B,

(c) an alkoxysilane crosslinker,

(d) an inorganic filler, and

(e) a catalyst,

where Ingredient (b), silane B, has the following general formula (I) or (II):

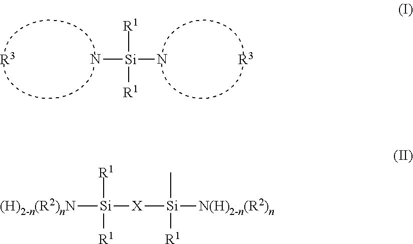

where R¹ can be the same or different, and is selected from among C1-C12 linear or branched hydrocarbon groups, preferably from among C1-C12 linear or branched alkyl groups, and C1-C12 hydrocarbon groups containing an olefinic bond, more preferably from among methyl, ethyl and vinyl groups;

R³ can be the same or different, and is selected from among C1-C12 linear or branched hydrocarbons, C1-C12 linear or branched divalent hydrocarbon groups and H, preferably from among methyl, ethyl, propyl, iso-propyl, n-butyl, sec-butyl and hexylene groups, more preferably from among propyl, iso-propyl, n-butyl and sec-butyl groups;

n is 0, 1, or 2, preferably 1;

R² can be the same or different, and is selected from among C1-C12 linear or branched hydrocarbon groups and H, preferably from among methyl, ethyl, propyl, n-butyl [CH₃—CH₂—CH₂—CH₂—], sec-butyl [CH₃—CH₂—CH(CH₃)—], iso-butyl [(CH₃)₂CH—CH₂—], tert-butyl [(CH₃)₃C-] and H, more preferably from among propyl, iso-propyl, n-butyl, sec-butyl and iso-butyl groups; and

X is selected from among groups of the general formula [—(R₂SiO)ₘ—], C1-C12 divalent hydrocarbon groups, groups of the general formula [—(C₂H₄O)ₚ(C₃H₆O)_{q}—], where R can be the same or different, selected from among C1-C12 alkyl groups, and is preferably a methyl group; and m, p and q are 0 or positive integers less than or equal to 10, preferably 0 or positive integers less than or equal to 3, while p and q are not equal to 0 at the same time;

and Ingredient (b), silane B, is present in an amount of less than or equal to 0.5 wt %, even more preferably less than or equal to 0.4 wt %, still more preferably less than or equal to 0.2 wt %, and most preferably from 0.01 to 0.1 wt %, based on the total weight, as 100 wt %, of the composition;

and Ingredient (d), an inorganic filler, is present in an amount of greater than or equal to 35 wt %, preferably greater than or equal to 45 wt %, more preferably greater than or equal to 50 wt %, and most preferably from 50 to 70 wt %, based on the total weight, as 100 wt %, of the composition.

According to the composition mentioned above, Ingredient (b), silane B, has the following general formula (III):

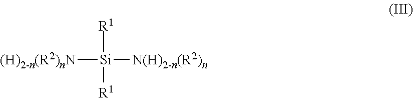

where R¹ can be the same or different, and is selected from among C1-C12 linear or branched hydrocarbon groups, preferably from among C1-C12 linear or branched alkyl groups, and C1-C12 hydrocarbon groups containing an olefinic bond, more preferably from among methyl, ethyl and vinyl groups;

n is 0, 1 or 2, preferably 1 or 2, more preferably 1;

R² can be the same or different, and is selected from among C1-C12 linear or branched hydrocarbon groups, and H, preferably from among methyl, ethyl, propyl, iso-propyl, n-butyl, sec-butyl, iso-butyl and tert-butyl groups, more preferably from among propyl, iso-propyl, n-butyl, sec-butyl and iso-butyl groups;

According to the composition mentioned above, Ingredient (b), silane B, is one or more selected from among dimethyl bis(s-butylamino)silane, dimethyl bis (diethylamino)silane, dimethyl bis (dimethylamino)silane, diethyl bis (s-butylamino) silane, and methyl-vinyl-bis(s-butylamino) silane.

According to the composition mentioned above, Ingredient (a) as the base polymer can be selected from among various hydroxyl-terminated polyorganosiloxanes or mixtures thereof conventionally used in the art for preparing RTV silicone rubbers, preferably being an α,ω-dihydroxypolydimethylsiloxane.

According to the composition mentioned above, Ingredient (a), a hydroxyl-terminated polyorganosiloxane, is present in an amount of from 10 to 85 wt %, preferably from 20 to 50 wt %, more preferably from 25 to 40 wt %, based on the total weight, as 100 wt %, of the raw materials of the composition.

According to the composition mentioned above, Ingredient (a) has a kinematic viscosity of from 1,000 to 350,000 mm²/s, preferably from 10,000 to 200,000 mm²/s, more preferably from 20,000 to 120,000 mm²/s, most preferably from 50,000 to 120,000 mm²/s, measured at 25° C. according to DIN 51562.

According to the composition mentioned above, Ingredient (b), silane B, is present in an amount of from 0.005 to 0.2 wt %, preferably from 0.01 to 0.15 wt %, more preferably from 0.01 to 0.05 wt %, based on the total weight, as 100 wt %, of Ingredient (a).

According to the composition mentioned above, Ingredient (c), an alkoxysilane crosslinker, is present in an amount of from 0.5 to 8 wt %, preferably from 0.5 to 5 wt %, based on the total weight, as 100 wt %, of the raw materials of the composition.

According to the composition mentioned above, Ingredient (c) is a silane that has three or more alkoxy groups (—OR, where R represents alkyl groups) and is conventionally used in the art for preparing alkoxy silane crosslinked RTV silicone rubbers, and preference is given to methyltrimethoxysilane, methyltriethoxysilane, vinyltrimethoxysilane, vinyltriethoxysilane, tetramethoxysilane, tetraethoxyoxysilane, phenyltrimethoxysilane, and phenyltriethoxysilane.

According to the composition mentioned above, Ingredient (d) selected from among various inorganic fillers conventionally used in the art, preferably one or more selected from the group consisting of calcium carbonate, silica, diatomaceous earth, bentonite, kaolin, talc, microsilica, titanium dioxide, aluminum oxide, quartz powder, and clay minerals, preferably from the group consisting of precipitated calcium carbonate, ground calcium carbonate, activated calcium carbonate, and fumed silica, and more preferably from the group consisting of fumed silica, and surface-treated precipitated and ground calcium carbonate.

According to the composition mentioned above, the fumed silica is preferably a hydrophilic silica that preferably has a BET surface area of from 100 to 300 m²/g, more preferably from 100 to 200 m²/g.

According to the composition mentioned above, the fumed silica is present in an amount of from 0.1 to 10 wt %, preferably from 1 to 5 wt %, more preferably from 2 to 5 wt %, based on the total weight, as 100 wt %, of the raw materials of the composition.

According to the composition mentioned above, the amount of Ingredient (e) can be determined by those skilled in the art according to its type and the expected curing rate, generally in the range of from 0.01 to 5 wt %, preferably from 0.1 to 3 wt %, more preferably from 0.5 to 3 wt %, based on the total weight, as 100 wt %, of the raw materials of the composition.

According to the composition mentioned above, the catalyst is one or more selected from among complexes of titanium and tin, preferably one or more from among alkoxy organotitanium, organotitanium compounds, and dialkyltin salts of carboxylic acids, and more preferably is one, or a combination, of tetrabutyl titanate, diisopropoxy-bisethylacetoacetato titanate, diisobutoxy-bisethylacetoacetato titanate, isopropyl titanate, polybutyl titanate, tetraisooctyl titanate, dibutyltin diacetate, dibutyltin dilaurate, dibutyltin maleate, dilauryltin diacetate, dioctyltin diacetate, dibutyltin-bis(4-methyl aminobenzoate), dibutyltin dilauryl mercaptide, or dibutyltin-bis(6-methyl aminocaproate).

The composition mentioned above further comprises Ingredient (f), a silicone resin, which has a dynamic viscosity of from 10,000 to 500,000 mPa·s at 25° C.

The silicone resin is beneficial to further reduce the 100% modulus of the cured elastomer, and can be any organosilicone resins known in the art, having the following general formula:

(M)ₐ(D)_{b}(T)_{c}(Q)_{d}

where M represents a monofunctional siloxy unit R₃SiO_{1/2}, D represents a difunctional siloxy unit R₂SiO_{2/2}; T represents a trifunctional siloxy unit RSiO_{3/2}; Q represents a tetrafunctional siloxy unit SiO_{4/2}; and at least one of a, b, c and d is non-zero.

According to the present invention, the silicone resin may comprise any one, or a combination, of the structural units M, D, T and Q, is preferably MD, MT, MQ, T, DT or MDT resin, more preferably MQ silicone resin, and has a dynamic viscosity at 25° C. of suitably less than 500,000 mPa·s, preferably from 10,000 to 500,000 mPa·s.

According to the present invention, Ingredient (f) is generally used in an amount of less than or equal to 10 wt %, preferably from 1 to 8 wt %, more preferably from 1 to 5 wt %, based on the total weight, as 100 wt %, of the raw materials of the composition.

According to the present invention, the composition can offer a reduced modulus at 100% elongation (hereinafter “100% modulus”) without a plasticizer (g), but an appropriate amount of the plasticizer may also be included to obtain a product with a further reduced 100% modulus.

According to the composition mentioned above, further including Ingredient (g1), a plasticizer, which is present in an amount of less than or equal to 20 wt %, preferably less than or equal to 15 wt %, more preferably less than or equal to 12 wt %, most preferably from 5 to 12 wt %, based on the total weight, as 100 wt %, of the raw materials of the composition.

Ingredient (g1), a plasticizer, is one or more selected from the group consisting of polydimethylsiloxanes having a dynamic viscosity of from 10 to 5000 mPa s, mineral oils having a kinematic viscosity of from 10 to 100 mm²/s, vegetable oils having a kinematic viscosity of from 10 to 100 mm²/s, and organic solvents, preferably one or more from the group consisting of polydimethylsiloxanes having a dynamic viscosity of from 10 to 5000 mPa s, and mineral oils having a kinematic viscosity of from 10 to 100 mm²/s, all the viscosity values here being measured at 25° C.

According to the present invention, the polydimethylsiloxane has the following general formula:

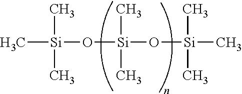

where n is a positive integer.

According to the composition mentioned above, Ingredient (g2), a plasticizer, is present in an amount of less than or equal to 5 wt %, preferably less than or equal to 2 wt %, more preferably less than or equal to 1 wt %, most preferably less than or equal to 0.1 wt %, based on the total weight, as 100 wt %, of the raw materials of the composition.

Ingredient (g2), a plasticizer, is selected from among small molecule compounds containing phenyl groups, preferably from among the small molecule esters or salts of phthalic acid.

According to the composition mentioned above, Ingredient (h), the second organic polymer/oligomer, is present in an amount of less than or equal to 5 wt %, preferably less than or equal to 2 wt %, more preferably less than or equal to 1 wt %, and most preferably less than or equal to 0.1 wt %, based on the total weight, as 100 wt %, of the raw materials of the composition.

Ingredient (h) comprises one or more polymers/oligomers selected from among silylated polyurethanes, MDI-terminated polyurethane prepolymers, reactive silylated polyols, and non-silylated acrylic functional polymers, as well as silylated or silylated butyl functional polymers that are selected from among styrene-butadiene, polybutadiene, and butyl rubbers.

Present invention preferably relates to a curable composition comprising

10 to 50 wt % of Ingredient (a), a hydroxyl-terminated polyorganosiloxane,

0.01 to 0.5 wt % of Ingredient (b), silane B, having the above-mentioned general formula (III),

0.5 to 8 wt % of Ingredient (c) an alkoxysilane crosslinker,

35 to 70 wt % of Ingredient (d), an inorganic filler, and

0.01 to 5 wt % of Ingredient (c) a catalyst.

Present invention more preferably relates to a curable composition comprising

25 to 40 wt % of Ingredient (a), a hydroxyl-terminated polyorganosiloxane,

0.01 to 0.2 wt % of Ingredient (b), silane B, having the above-mentioned general formula (III),

0.5 to 5 wt % of Ingredient (c), an alkoxysilane crosslinker,

40 to 60 wt % of Ingredient (d), an inorganic filler, and

0.01 to 5 wt % of Ingredient (c), a catalyst.

The composition mentioned above is a one-component or one-package system.

The present invention also provides an elastomer that is obtained by curing the above-mentioned composition.

The elastomer mentioned above has a 100% modulus of less than or equal to 0.7 MPa, preferably less than or equal to 0.4 MPa, more preferably from 0.3 to 0.4 MPa, measured according to ISO 11600:2002.

According to the composition of the present invention, the silanes having two or more acetoxy groups [—O—C(═O)—CH₃] are present in a total amount of less than 3 wt %, preferably less than 2 wt %, more preferably less than 1 wt %, even more preferably less than 0.5 wt %, most preferably from 0 to 0.1 wt %, based on the total weight, as 100 wt %, of the raw materials of the composition. Such silanes are selected from among diacetoxysilanes, triacetoxysilanes, and tetraacetoxysilanes. With such silanes used in a very small or even zero amount, the composition is an alkoxy silane crosslinked product that mainly releases alcohol as by-products during the curing process.

According to the composition mentioned above, the silanes having two or more ketoxime groups ([—O—N═CR₂], where R represents alkyl groups) are present in a total amount of less than 3 wt %, preferably less than 2 wt %, more preferably less than 1 wt %, even more preferably less than 0.5 wt %, most preferably from 0 to 0.1 wt %, based on the total weight, as 100 wt %, of the raw materials of the composition. Such silanes are selected from among bis(ketoxime)silanes, tris(ketoxime)silanes, and tetra(ketoxime) silanes. With such silanes used in a very small or even zero amount, the composition is an alkoxy-based product that mainly releases alcohol as by-products during the curing process.

The bis(ketoxime)silane can be one or a mixture of several ones selected from among dimethylbis (methylethylketoxime) silanes, methyl-vinyl-bis (methylethylketoxime) silanes, and diethylbis (methylethylketoxime) silanes.

The diacetoxysilane can be one or a mixture of several ones selected from dimethyl diacetoxysilanes and methylvinyl diacetoxysilanes.

The composition of the present invention still offers the advantages of “alkoxy silane crosslinked RTV silicone rubbers”, has extremely low contamination and corrosion, and can be used as sealants, adhesives or coating materials for the applications in construction, electronics, electric and automobile sectors.

The composition of the present invention may also optionally comprise other conventional aids and additives, such as UV absorbers (e.g. salicylic acid ester, benzotriazole, substituted acrylonitrile and triazine UV absorbers), and UV stabilizers (e.g. hindered amine light stabilizers), but are not limited thereto.

The amounts of all ingredients herein are, unless otherwise specified, in parts by weight.

In the present invention, viscosity is measured according to DIN 53019.

The present invention is further illustrated by the following examples, but the scope is not limited thereby. Any experimental methods with no conditions specified in the following examples are selected according to the conventional methods and conditions, or product specifications.

Test Method

1. Determination of Shore a Hardness

The Shore A hardness of the cured composition (hereinafter referred to as “elastomer”) of the present invention is determined in accordance with ISO 868-2003 (or Chinese Standard GB/T 2411-2008).

2. Measurement of Tensile Strength, Elongation at Break and 100% Modulus.

The tensile strength, elongation at break, and 100% modulus of the elastomer of the present invention are measured in accordance with ISO 11600:2001.

As used herein, “100% modulus” refers to the modulus at 100% elongation of a test sample measured in accordance with the aforesaid standard.

The compositions are obtained by mixing the ingredients as per their respective amounts listed in Table 1 under water removal or controlled humidity conditions.

Table 1 shows the ingredients of Examples and Comparative Examples and amounts thereof, which are, unless otherwise specified, in parts by weight:

Hydroxypolydimethylsiloxane 1, an α,ω-dihydroxypolydimethylsiloxane, having a dynamic viscosity of about 75,000 mPa·s, measured at 23° C. according to DIN 53019,

Polydimethylsiloxane 1, having a dynamic viscosity of from 95 to 105 mPa·s, measured at 25° C. according to DIN 53019,

Dimethylbis(s-butylamino)silane,

Vinyltrimethoxysilane,

Fumed silica, a hydrophilic pyrogenic silica, having a BET surface area of from 150 to 170 m²/g,

Silicone resin 1, a MQ silicone resin, having a dynamic viscosity of from 10,000 to 500,000 mPa·s,

The above-mentioned raw materials are supplied by Wacker Chemicals.

Ground calcium carbonate, surface-treated, having a particle size of about 5 μm, commercially available,

Catalyst, diisopropoxy-bisethylacetoacetato titanate, commercially available.

TABLE 1

| | Ex.1 | Ex.2 | C.Ex.3 |
|---|---|---|---|
| Hydroxypolydimethylsiloxane 1 | 30 | 30 | 30 |
| Dimethylbis(s-butylamino)silane | 0.043 | 0.4 | 2 |
| Vinyltrimethoxysilane | 2 | 2 | 2 |
| Polydimethylsiloxane 1 | 10 | 10 | 10 |
| Catalyst | 1.5 | 1.5 | 1.5 |
| Ground calcium carbonate | 51.2 | 50.8 | 49.2 |
| Fumed silica | 3.3 | 3.3 | 3.3 |
| Silicone resin 1 | 2 | 2 | 2 |

TABLE 2

| Test Data | Ex.1 | Ex.2 | C.Ex.3 |
|---|---|---|---|
| Skin Forming Time, min | 41 | 120 | / |
| Hardness, shore A | 24.2 | 21.28-18.3 | / |
| Tensile strength, Mpa | 1.28 | 1.275 | / |
| Elongation at break, % | 658.7 | 656 | / |
| 100% Modulus, Mpa | 0.37 | 0.385 | / |

Table 2 shows the results of performance tests for Shore A hardness, tensile strength, elongation at break and 100% modulus of the elastomers of the Examples obtained after curing at room temperature (23±2° C.) for 7 days. As can be seen from Table 2, the elastomers of Ex.1 and Ex.2 have a lower modulus and the 100% modulus is lower than 0.4 MPa. Adding a small amount of silane B in the compositions with a high inorganic filler content (more than 50 wt %) can significantly reduce the modulus of the elastomers.

In general, the higher the inorganic filler content in the composition, the higher the modulus of cured elastomer. The compositions with a high inorganic filler content of the invention can also achieve a lower 100% modulus after curing.

The elastomer of Ex.1 has better mechanical and adhesion properties.

The composition obtained from mixing the components of C.Ex.3 did not cure to form an elastomer after storage at room temperature for 7 days. The too large amount of Ingredient (b), silane B, has a negative impact on the workability of the composition.

1.-12. (canceled)

13. A curable composition, comprising:
(a) a hydroxyl-terminated polyorganosiloxane,
(b) a silane B,
(c) an alkoxysilane crosslinker,
(d) an inorganic filler, and
(e) a catalyst,
wherein silane B has the following formulae (I) or (II): 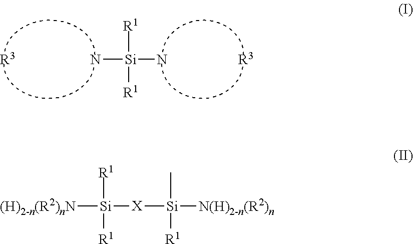
where R¹ each is the same or different, and is a C1-C12 linear or branched hydrocarbon group or a C1-C12 hydrocarbon group containing an olefinic bond,
R³ each is the same or different, and is a C1-C12 linear or branched hydrocarbon, C1-C12 linear or branched divalent hydrocarbon group;
n is 0, 1, or 2;
R² each is the same or different, and is a C1-C12 linear or branched hydrocarbon group, or H, and
X is of one of the formulae [—(R₂SiO)ₘ—], C1-C12 divalent hydrocarbon group or a group of the formula [—(C₂H₄O)ₚ(C₃H₆O)_{q}—], where R each is the same or different and is an C1-C12 alkyl group, and m, p and q are 0 or positive integers less than or equal to 10, wherein p and q are not equal to 0 at the same time;
silane B is present in an amount of less than or equal to 0.5 wt %, based on the total weight of the composition; and
Ingredient (d), an inorganic filler, is present in an amount of greater than or equal to 35 wt %, based on the total weight, as 100 wt %, of the composition.

14. The composition of claim 13, wherein Ingredient (b), silane B, has the following formula (III): 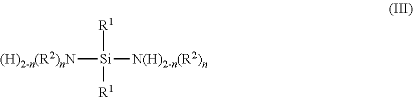
where R¹ each is the same or different, and is a C1-C12 linear or branched hydrocarbon groups or a C1-C12 hydrocarbon group containing an olefinic bond,
n is 0, 1 or 2, and
R² each is the same or different, and is a C1-C12 linear or branched hydrocarbon group, or H.

15. The composition of claim 13, wherein at least one silane B, is selected from the group consisting of dimethyl bis(s-butylamino)silane, dimethyl bis (diethylamino) silane, dimethyl bis (dimethylamino)silane, diethyl bis (s-butylamino) silane, and methyl-vinyl-bis(s-butylamino)silane.

16. The composition of claim 13, wherein the hydroxyl-terminated polyorganosiloxane is present in an amount of from 10 to 85 wt % based on the total weight of the composition.

17. The composition of claim 13, wherein silane B, is present in an amount of from 0.005 to 0.2 wt % based on the total weight of Ingredient (a).

18. The composition of claim 13, wherein Ingredient (c) is present in an amount of from 0.5 to 8 wt % based on the total weight of the composition.

19. The composition of claim 13, wherein Ingredient (d) is selected from the group consisting of calcium carbonate, silica, diatomaceous earth, bentonite, kaolin, talc, microsilica, titanium dioxide, aluminum oxide, quartz powder, clay minerals, and mixtures thereof.

20. The composition of claim 13, comprising Ingredient (f), a silicone resin, present in an amount of less than or equal to 10 wt %, based on the total weight of the composition

21. The composition of claim 13, further comprising Ingredient (g1), a plasticizer, present in an amount of less than or equal to 20 wt % based on the total weight, wherein the plasticizer is selected from the group consisting of polydimethylsiloxanes having a dynamic viscosity of from 10 to 5000 mPa s, mineral oils having a kinematic viscosity of from 10 to 100 mm²/s, vegetable oils having a kinematic viscosity of from 10 to 100 mm²/s, organic solvents, and mixtures thereof, all the viscosity values measured at 25° C.

22. A curable composition of claim 14, comprising:
10 to 50 wt % of Ingredient (a), a hydroxyl-terminated polyorganosiloxane,
0.01 to 0.5 wt % of silane B having the formula (III),
0.5 to 8 wt % of Ingredient (c), an alkoxysilane crosslinker,
35 to 70 wt % of Ingredient (d), an inorganic filler, and
0.01 to 5 wt % of Ingredient (e), a catalyst.

23. A curable composition of claim 14, comprising:
25 to 40 wt % of Ingredient (a), a hydroxyl-terminated polyorganosiloxane,
0.01 to 0.2 wt % of silane B, having the general formula (III),
0.5 to 5 wt % of Ingredient (c), an alkoxysilane crosslinker,
40 to 60 wt % of Ingredient (d), an inorganic filler, and
0.01 to 5 wt % of Ingredient (e), a catalyst.

24. An elastomer obtained by curing a composition of claim 13, the 100% modulus of which is less than or equal to 0.7 MPa.

25. An elastomer obtained by curing a composition of claim 13, the 100% modulus of which is less than or equal to 0.4 MPa.
